(19) United States
(12) Patent Application Publication
(10) Pub. No.: US 2017/0158166 A1
(43) Pub. Date: Jun. 8, 2017

(54) LOCKING DEVICE

(71) Applicant: Huf Hülsbeck & Fürst GmbH & Co. KG, Velbert (DE)

(72) Inventor: Werner TRISCHBERGER, Langenpettenbach (DE)

(21) Appl. No.: 15/367,233

(22) Filed: Dec. 2, 2016

(30) Foreign Application Priority Data
Dec. 2, 2015 (DE) 10 2015 121 000.2

(51) Int. Cl. B60R 25/021; B60R 25/00

(52) U.S. Cl. CPC B60R 25/02126; B60R 25/007

(57) ABSTRACT

The invention relates to a locking device (70), in particular a steering wheel lock (70), for a vehicle, for a functionally-essential component (74), in particular in the form of a steering column or a gearshift lever or the like, having at least one manually actuable, in particular rotatable, operating part (10), wherein at least two rotational positions (0, III) can be assumed by the operating part (10), namely an off position (0) and a start position (III), wherein in the off position (0), at least one engine of the vehicle can be turned off and/or the functionally-essential component (74) can be fixed by a blocking pin (71) in a locked position, and in the start position (III), at least one consumer, in particular a starter of the vehicle can be turned on and/or the functionally-essential component (74) can be released by a blocking pin (71) in an unlocked position.

It is provided according to the invention that a mechanical reset barrier (15) is provided, which prevents a reset of the operating part (10) at least from the start position (III) into the off position (0), by a, in particular simple, rotation of the operating part (10), into a blocking position (S), wherein the mechanical reset barrier (15) is formed by a control element (72), which mechanically interacts at least with the operating part (10), and a stationary guide cam, which jointly fix the operating part (10) at least in a formfitting manner in the blocking position (S).

### RELATED APPLICATION

This application claims the benefit of priority of German Patent Application No. 10 2015 121 000.2 filed Dec. 2, 2015, the contents of which are incorporated herein by reference in their entirety.

### FIELD AND BACKGROUND OF THE INVENTION

The present invention is directed to a locking device, for example, a steering wheel lock in a vehicle, having an operating part, in particular in the form of a lock cylinder, according to the preamble of Claim 1. Such locking devices having operating part or lock cylinders as the operating part are mechanically complex components.

Diverse locking devices in the form of steering wheel locks having lock cylinders for motor vehicles are known from the prior art, thus, for example, from document DE 42 19 846 C2. Such locking devices can be used in a vehicle in the region of the steering column, the brake pedal, or the gearshift lever and are manually actuated by the operating part or a matching key. In particular, upon use of a manual operating part or a lock cylinder in the case of a steering wheel lock, for example, increased security is necessary, because incorrect operations by the vehicle driver can rapidly result in undesired electrical and/or mechanical switching states in the vehicle, which can then result in an accident. Thus, for example, an undesired displacement of the operating part or the lock cylinder into an off position, can have the result that all electrical consumers of the vehicle are turned off, for example, also the engine, the power steering, the brake booster, an antilock brake system for the brakes, etc. As a result, a drastically increased risk of accident is provided in this way. In addition, further requirements exist for such operating parts or lock cylinders upon use in a locking device, for example, to avoid renewed starting of the already running engine of the vehicle by the starter. Starting repetition barriers, as are disclosed in document EP 2 253 519 A1, for example, are used for this purpose.

### SUMMARY OF THE INVENTION

The object of the present invention is therefore to provide a locking device, in particular a vehicle, which overcomes at least one disadvantage from the prior art. In particular, it is an object of the invention to provide increased security, in particular functional reliability, in addition to security from theft and/or break-in. Furthermore, it is in particular an object of the invention to make the handling and/or the manufacturing of the locking device as simple and reliable as possible.

The present object is achieved by a locking device having the features of Claim 1, in particular from the characterizing part. Preferred refinements of the invention are set forth in the dependent claims. Features which are disclosed for the manually actuable operating part also apply in this case to the lock cylinder, in particular the cylinder core, and vice versa in each case, so that reference is reciprocally made in each case between the individual aspects of the present invention.

The locking device according to the invention can be in particular a steering wheel lock for a vehicle, which can block a functionally-essential component, in particular in the form of a steering column, brake pedal lever, or a gearshift lever or the like. For this purpose, a blocking pin can be provided in the locking device, which blocks or fixes the functionally-essential component in a locked position and can release the functionally-essential component in an unlocked position. A manual operating part, actuating element, or a lock cylinder for a key is provided to activate the locking device, which are manually actuable by an operator. In the present invention, the operating part or actuating element, precisely like the mechanically actuable lock cylinder, is used as the mechanical activation element for the locking device, whereby the blocking pin and therefore the functionally-essential component can finally be fixed or released. The operating part (or the actuating element) and the mechanical lock cylinder, in particular the cylinder core, which is rotatable by a key, are thus understood as synonymous. A rotation or pressure movement on the operating part (or on the actuating element) is therefore directly comparable to a rotation or a press on the key, which is insertable into a key channel of the rotatably mounted cylinder core in the cylinder housing.

In the locking device according to the invention, it is provided that a mechanical reset barrier is provided, which prevents a reset of the operating part at least from the start position into the off position by a, in particular simple, rotation of the operating part into a blocking position. In this case, the mechanical reset barrier is formed by a control element and a stationary guide cam (or the kinematic reversal is also conceivable), which jointly fix the operating part at least in a formfitting manner in the blocking position. The control element itself interacts at least mechanically with the operating part in this case. By using the mechanical reset barrier, it is not possible to reach the off position at least from the start position by a simple rotation of the operating part. Rather, a further actuating movement is necessary to overcome the mechanical reset barrier and therefore, for example, turn off an engine of the vehicle and/or fix (this means secure) the functionally-essential component by way of a blocking pin. Therefore, an undesired backward rotation of the operating part or the key inserted into the cylinder core can be reliably avoided. Overall, the risk of accident in a vehicle can thus be reduced, because even in the event of substantial shocks and mechanical actions on the locking device, undesired backward rotation of the operating part or the cylinder core is not readily possible as a result of the provided reset barrier.

It is also to be noted here that the control element can also form a transport safeguard (for the locking device) with the stationary guide cam. It is thus conceivable that the locking device is transported without a corresponding mechanical lock cylinder (or operating part) and in this case the transport safeguard mechanically holds together the locking device such that only the mechanical lock cylinder (or the operating part) has to be installed before the installation in the vehicle. In this case, stationary guide cam can secure the control element in the steering wheel lock housing mechanically, preferably in a formfitting manner (until the mechanical lock cylinder is installed). Therefore, two different technical functions can be achieved by the control element and the stationary guide cam, because they can form the mechanical reset barrier, on the one hand, and the transport safeguard, on the other hand.

It can be provided within the scope of the invention that the operating part can be blocked by a securing element at least in the off position. This securing element can be activated solely mechanically or electro-mechanically, wherein, for example, a mobile ID encoder can be used to release the securing element on the operating part. This means that as soon as an electronics unit on the vehicle has recognized the correct ID encoder, an activation of the securing element for the operating part is performed, so that it is no longer blocked in the off position and is manually actuable freely by the operator. An electronic key can also interact mechanically with the operating part through its housing, for example, to be able to manually pivot it in principle, wherein the electronics of the electronic key are used for the purpose of releasing the securing element beforehand.

It is preferably provided in the present invention that the reset barrier prevents a reset of the cylinder core from a travel position into the off position, in particular into an ACC position, by way of a simple rotation of the cylinder core or the operating part. This means that simply rotating the cylinder core is just not sufficient to rotate the cylinder core backward from its travel position into the ACC position or additionally into the off position. Rather, an intentional actuation of the reset barrier has to be performed by the vehicle driver.

It can advantageously additionally be provided within the scope of the invention that the reset barrier prevents a reset of the cylinder core from a travel position into the off position by exclusively rotating the cylinder core in particular. This means that simply rotating the cylinder core into the off position is just not possible. Rather, an actuation of the reset barrier also has to be performed when the cylinder core is to be transferred from the travel position into the off position or even into the ACC position. Therefore, a reset of the cylinder core from the travel position into the ACC position can already be blocked by the reset barrier. Because the off position comes after the ACC position during the reset procedure of the cylinder core, the reset barrier prevents an undesired reset of the cylinder core very early, so that a particularly high safety standard is implemented, because in the ACC position (ACC stands for accumulator), the electrical consumers of the vehicle can be turned on and also remain turned on when the cylinder core is already in the travel position. It is therefore not possible to transfer the cylinder core from the travel position back into the ACC position or even the off position involuntarily and unintentionally solely by a simple rotation.

It can furthermore be provided according to the invention that the cylinder core has at least three stable rotational positions, namely an off position, an ACC position, and a travel position, in which the operating part and the cylinder core is fixed by a fixing element, in particular in a friction-locked and formfitting manner. This fixing element can be embodied, for example, as a ball catch, and can interact directly with the cylinder core to fix the cylinder core in the above-mentioned stable rotational positions, from which the cylinder core can be rotated via the key into the next rotational position by a force action which is only slightly elevated. However, the fixing element can also be provided in a downstream ignition switch, which then generates the stable rotational positions of the cylinder core. A corresponding ignition switch can be mechanically operationally connected to the lock cylinder easily via a coupling element.

Furthermore, it is conceivable according to the invention that the rotatable operating part is embodied in the form of a lock cylinder, as already mentioned above. The lock cylinder itself is actuable in this case by the matching key, wherein the lock cylinder has at least one cylinder housing and one cylinder core. The cylinder core in the cylinder housing is accommodated so it is at least rotatable in this case, wherein at least one blocking element is provided in the cylinder core, which prevents a rotation of the cylinder core in the cylinder housing in a blocking position and releases a rotation in the cylinder housing in a release position, and wherein a key channel extends through the cylinder core, into which the key is insertable and using which the blocking element is movable between the blocking position and the release position. At least two rotational positions can be assumed or taken by the cylinder core, wherein the key is insertable into and removable from the key channel in the off position. In the present case, the lock cylinder is therefore optionally embodied as the mechanically actuable operating part, which has also been referred to as synonymous above. The locking device can therefore easily be adapted specifically to the vehicle and individually by the vehicle for the customer wishes.

Furthermore, it is possible within the scope of the invention that the control element is connected in a rotationally-fixed manner to the operating part or the cylinder core. “Rotationally fixed” is understood in this case to mean that a rotation is transmittable from the operating part or the cylinder core to the control element. This transmission of the rotational movement ideally takes place without slip, so that no relative rotational movement is provided between the control element and the operating part or the cylinder core. A driver is advantageously provided between the operating part and the cylinder core and the control element for the rotationally-fixed connection. The driver is therefore used for the purpose of transmitting the rotation initiated at the operating part or cylinder core to the control element. A particularly simple torque transmission is thus possible between the operating part or the cylinder core or the control element.

Furthermore, it can be possible according to the invention that the control element is mounted so it is axially displaceable in relation to the operating part or the cylinder core, in particular by a driver. Relative rotational movement is thus not possible between the operating part or the cylinder core and the control element, but a longitudinal or axial displacement is possible. This axial movement is necessary to implement various further functions of the locking device according to the invention in a simple manner. For example, the design of the reset barrier and a key withdrawal safeguard can be achieved particularly elegantly by the axial displacement. Furthermore, it is conceivable that the driver is embodied as a multi-tooth axis or a polygonal axis on the operating part or on the cylinder core. For this purpose, the driver can be embodied as directly materially bonded to the operating part or the cylinder core. This driver interacts mechanically with a recess on the control element, which is embodied as geometrically complementary, to form the rotationally-fixed connection between operating part or the cylinder core or the control element. Of course, a kinematic reversal between driver and recess is also conceivable, so that instead of the driver, a recess can be provided, and instead of the recess, a driver can be provided. A mechanically elegant connection for the driver and the recess which interacts with it is thus formed, these elements forming a longitudinally displaceable but rotationally-fixed connection.

It is also possible within the scope of the invention that a control contour, in particular for the blocking position (S), is provided on the control element, which interacts with a counter stroke contour on the lock cylinder, in particular on the cylinder housing, to cause an axial displacement of the control element upon a rotation of the operating part or the cylinder core. A mechanical reset barrier can also be implemented by a specific geometrical design of the connection between control element and lock cylinder, in particular the counter stroke contour on the cylinder housing and the control contour on the control element, which mechanically interact with one another.

Furthermore, it is conceivable that the control element has a blocking curve, in which the stationary securing cam engages, whereby the mechanical reset barrier is formed. In this case, the guide cam can predefine the rotation and longitudinal displacement of the control element in a housing of the locking device by way of the interaction with the control curve. As already mentioned, a kinematic reversal is also fundamentally conceivable in this case. A projection can advantageously be provided in the blocking curve, to hold the guide cam in a fixed and formfitting manner in the blocking position (blocking location A of the reset barrier). In the blocking position, a further rotation of the control element can therefore be prevented in that the guide cam interacts in a formfitting manner with the projection in the control curve and thus prevents a backward rotation of the control element in the direction of the off position. Particularly reliable securing of the control element in the blocking position is thus provided.

It is also conceivable that the blocking curve is arranged on the outside on the control element. The control curve can itself be attached in the form of an insert in the control element, wherein the insert can be formed from hardened material, in particular metal or wear-resistant plastic. The control curve is then worked into this insert, wherein the insert is in turn connected in a formfitting, force-fitting, and/or materially bonded manner to the control element. The control element advantageously has a cylindrical region, on which the control curve is worked or arranged directly or indirectly via the insert. The mechanical reset barrier is formed in a particularly simple manner and without additional components by the control curve additionally provided on the control element. If an insert is also used to embody the control curve, a particularly stable and low-wear reset barrier can be formed.

Furthermore, at least one first control cam for an actuation of the locking pin for the functionally-essential component can be provided on the control element. In this case, the control cam can be used to convert a rotational movement of the control element into a longitudinal movement of the blocking pin. The control cam can advantageously be arranged radially on a transmission part of the control element. In this way, the number of the components for the locking device according to the invention may be reduced further and the overall structure may be simplified.

It is also conceivable that at least one second (optionally in relation to the first) control cam, which is provided for an actuation of the blocking pin, in particular in the blocking position, is arranged in a longitudinally-displaceable or rotationally-fixed manner on a transmission part of the control element, which is embodied as axle-shaped in particular. The second control cam therefore assumes a similar or identical task as the above-described first control cam. However, the second control cam can be arranged in a stationary manner (this means without longitudinal displacement, for example) in the housing of the locking device and can only follow a rotational movement of the control element. A longitudinal displacement of the control element does not result, via the axially displaceable embodiment of the second control cam in relation to the control element, in a displacement of the second control cam (in particular in relation to the housing of the locking device). The longitudinal displacement ability of the second control cam in relation to the control element, in particular in relation to the transmission part of the control element, is required for this purpose. Furthermore, at least one spring element can be provided between the second control cam and the control element. This spring element can be embodied as a compression spring and fundamentally presses the control element in the direction of the operating part or the lock cylinder. The control element ideally forms a one-piece component with the transmission part and the first control cam, which can be embodied in particular as monolithic and from a uniform material. The second control cam can also be arranged with the aid of an arranged guide sleeve on the control element, in particular the transmission part, wherein the second control cam—as already mentioned—is rotationally fixed in relation to the control element, in particular the transmission part. A multi-tooth axis or a polygonal axis on the transmission part can be used for this purpose, as already described in the case of the driver. A ring-shaped section is ideally provided on the transmission part, which interacts with the spring element. In addition, a bulge can be provided on the transmission part, which can interact at least in a form-fitting and/or force-fitting manner with the second control cam, to hold the second control cam on the transmission part of the control element. Therefore, the control element, which is embodied as monolithic in particular, having the transmission part and the first control cam can also be embodied in one piece with the spring element and the second control cam. The spring element is slipped in this case over the axle-shaped part of the transmission part and can be arranged below the sleeve-shaped second control cam between the control cam and the ring-shaped shoulder. The above-described embodiment has the advantage that a simple installation of the above-described control element in the housing of the locking device is possible, because individual components do not have to be installed, but rather the preassembled control element is installed jointly directly with the second control cam. The second control cam can be at least temporarily secured with its sleeve-shaped extension over the bulge on the transmission part for this purpose. Nonetheless, the second control cam is arranged in a rotationally-fixed manner, but relatively displaceable, on the transmission part by the control element against the force of the spring element. The mentioned spring element can be provided as a single spring element for an independent displacement of the control element along its rotational axis, which is also still optionally possible for the operating part. Therefore, only precisely one spring element is used for the independent longitudinal displacement of the control element and operating part or cylinder core.

In addition, it is to be noted at this point that the operating part or the cylinder core and the control element and the ignition switch can all be connected to one another (are connectable) in a rotationally-fixed manner, wherein an axial gap is possible at least partially between the mentioned components.

Furthermore, it is conceivable according to the invention that a transmission part of the control element transmits a rotational movement of the control element to an ignition switch, which is mechanically attached to the locking device. The manual actuation of the operating part or the cylinder core can thus also be used directly for actuating the ignition switch. In this case, the axial free end of the transmission part of the control element—similarly to the above-described driver—can interact with a corresponding recess on the ignition switch, to transmit a rotational movement, but possibly not a longitudinal movement.

Furthermore, it is conceivable that precisely one spring element for generating a counterforce for the manually generated pressure force is provided on the operating part or the cylinder core. In this case, this can be the already described spring element between the control element and the second control cam. Therefore, further spring elements for the longitudinal displacement of the control element and/or the operating part and/or the cylinder core can be omitted. A particularly simple structure of the overall locking device is thus possible.

It is also conceivable that at least the first and second control cams are arranged axially offset on the transmission part of the control element and both interact (directly or indirectly) with the blocking pin for the functionally-essential component, to move or hold the blocking pin between a locked and unlocked position. Because the first control cam is directly connected to the control element, the first control cam is also axially displaced with the control element during a manual actuation. The location of the first control cam in relation to the blocking pin also changes in this way. However, to be able to actuate the blocking pin reliably, the second control cam is advantageously arranged in a stationary manner in the housing of the locking device, to be able to assume the same task of the first control cam reliably.

To achieve a particularly compact structure of the locking device, a movement direction of the blocking pin can be arranged transversely in relation to the rotational axis of the control element. It is conceivable in this case that the blocking pin is mounted by a spring element and is pressed into the locked position. The so-called “tooth-on-tooth problem” can thus be elegantly solved in the locking device in a reliable manner. In this case, the blocking pin always attempts to extend into the locked position, wherein it is pressed by the spring element into this locked position and also moves in therein, if a corresponding free space is provided between two teeth on the moving part. If this free space is not provided, forced guiding of the blocking pin is avoided by the use of the spring element. However, as soon as a free space is provided for the blocking pin in the locked position, the spring element presses the blocking pin automatically into this locked position.

To achieve the longitudinal displacement of the control element by way of a rotation on the operating part or on the cylinder core, a control curve can be provided in the control element, which interacts with a counter contour on the operating part or on the lock cylinder. In this case, the control element, in the event of an initiated rotational movement, slides with its control contour along the counter contour and is thus axially displaced. This axial displacement is also enabled by the control curve on the control element in interaction with the stationary guide cam. Depending on the rotational position of the operating part or the cylinder core, a displacement of the blocking pin from its locked position into its unlocked position is caused simultaneously. The control element embodied according to the invention, having the control contour and the blocking curve, therefore assumes various tasks in the locking device, wherein the control element is embodied as an integral component, in particular monolithically.

Furthermore, it is conceivable that an (in particular solely mechanical) key withdrawal safeguard is provided, to hold the blocking pin in the unlocked position until the key is withdrawn from the lock cylinder in the off position. An electromechanical key withdrawal safeguard is also conceivable, which electrically detects a position of the key or the operating part and holds the blocking pin in its unlocked position accordingly. The mechanical key withdrawal safeguard is advantageously formed on the lock cylinder and fixes the control element axially in its displaced location at least in the off position. In this case, an extendable fixing cam can be provided on the key withdrawal safeguard, which interacts with the control element. The fixing cam can additionally mechanically interact with a key sensor, which senses the position of the key in the key channel and mechanically transmits it to the fixing cam. It can be ensured by the key withdrawal safeguard that the locking device first blocks the functionally-essential component when the key is at least partially or also completely withdrawn from the channel of the cylinder core. The key withdrawal safeguard can be arranged radially in the outer region of the cylinder housing, wherein the extendable fixing cam is spring-loaded by a spring element and can be secured by a catch element in its extended location.

To increase the security of the locking device according to the invention, it is conceivable that the operating part or the cylinder core is mounted so it is rotatable and axially displaceable, in particular in relation to the cylinder housing, in its release position (and exclusively in its release position), in particular using the matching key. In this case, an axial displacement can be enabled only in the region of the blocking position by a control curve. In this case, the form fit between the shoulder in the control curve and the stationary cam blocks the reset of the operating part or the cylinder core into the off position.

It is conceivable according to the invention that the form fit between the projection in the control curve and the stationary guide cam can be canceled by the axial displacement of the operating part or the cylinder core in relation to the cylinder housing in the blocking position, whereby a reset of the operating part or the cylinder core in the direction of the off position is implementable. However, it is therefore also ensured that just a simple rotation from the blocking position in the direction of the off position is mechanically blocked by the reset barrier.

It has proven to be particularly advantageous if the lock cylinder is arranged by way of a replacement barrier in the housing of the locking device. If the lock cylinder should no longer interact properly with the matching key as a result of wear, only the lock cylinder can thus be replaced, whereby the remaining locking device can remain on the vehicle, which is not replaceable or is only replaceable with difficulty more or less as a result of its securing function. In this case, the replacement barrier can have formed a form fit between the lock cylinder, in particular the cylinder housing, and the housing of the locking device to secure the lock cylinder. This replacement barrier can consist of a curved blocking part, so that it enters a curved recess in the housing of the locking device, as soon the lock cylinder is properly installed.

Furthermore, it is possible that the stationary guide cam is formed as stationary in relation to the housing of the locking device. The stationary guide cam can itself be formed from hard material, in particular steel or a wear-free cast alloy. The stationary guide cam can also be fixedly connected to the housing and/or can be formed by the housing itself. Because the guide cam regulates the rotational and axial displacement of the control element inside the locking device, it is particularly advantageous if it is itself not movable in relation to the housing. The guide cam can also be arranged on a sleeve in the housing, however, and does not have to be directly connected to the housing. Also, the property “stationary” in the case of the guide cam is to describe its position in relation to the housing. The guide cam itself can be embodied as extendable and retractable in a spring-loaded manner, however, to enable simplified installation of the locking device according to the invention.

It is also possible within the scope of the invention that a starting repetition barrier is provided in or on the ignition switch, to block a repeated rotation of the operating part or the cylinder core into the start position without a (prior) reset. An overload of an electrical starter in the vehicle can be reliably avoided in this manner.

### BRIEF DESCRIPTION OF THE SEVERAL VIEWS OF THE DRAWINGS

Further measures and advantages of the present invention result from the claims, the following description, and the drawings. The disclosed features of the operating part also apply to the lock cylinder and vice versa. The invention is illustrated in different exemplary embodiments in the drawings. In this case, the features mentioned in the claims and the description can each be essential to the invention individually or in any arbitrary combination. In the figures:

FIG. 1 shows a schematic illustration of the locking device according to the invention in a quasi-exploded view of the individual components,

FIG. 2 shows a schematic illustration of the activation of the locking pin on a functionally-essential component by a first or second control cam of the control element,

FIG. 3 shows a three-dimensional schematic view of the control element with the first and second control cams,

FIG. 4 shows a three-dimensional view of a cutaway housing of a locking device,

FIGS. 5a-b show detail views of the lock cylinder or the operating part with a control curve for the release of a blocking position by a stroke movement,

FIG. 5c shows a detail view of a key withdrawal safeguard in the region of the lock cylinder,

FIG. 6a shows a schematic top view of an operating part or a lock cylinder in an off position,

FIG. 6b shows a comparable top view from FIG. 6a with an inserted key in the lock cylinder in the off position of the cylinder core, and

FIG. 6c shows a comparable top view to FIGS. 6a and 6b in a further exemplary embodiment in a travel position of the lock cylinder.

In the following figures, identical reference signs are also used for the same technical features of different exemplary embodiments of the invention.

### DESCRIPTION OF SPECIFIC EMBODIMENTS OF THE INVENTION

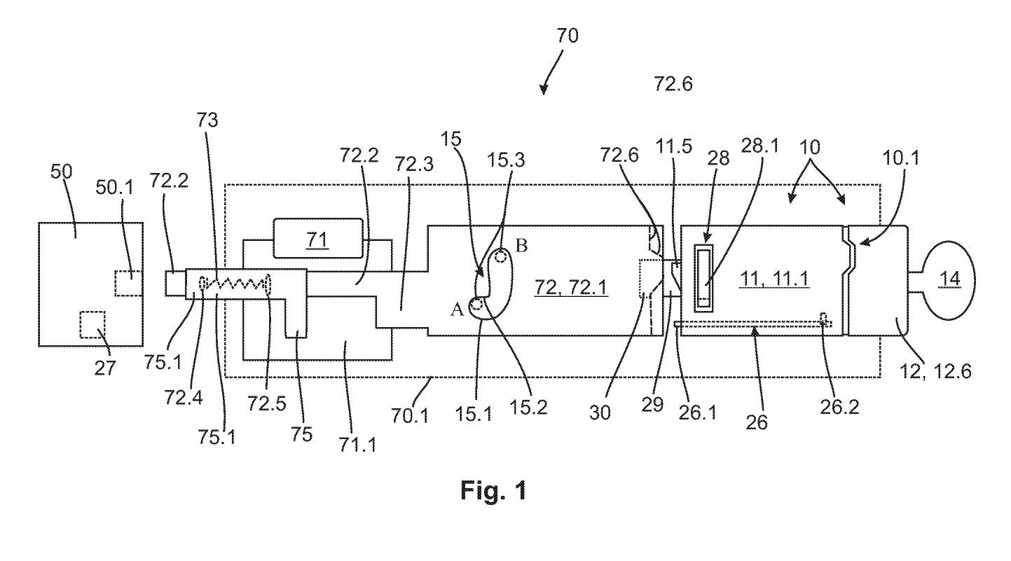

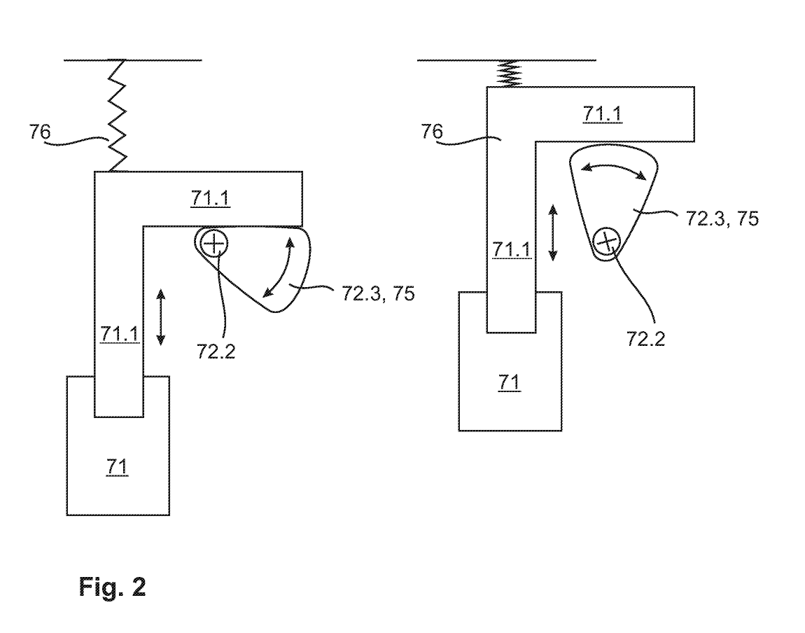

FIG. 1 shows a schematic overview of the locking device 70 according to the invention in an overview exploded illustration for clarification. In this case, a functionally-essential component 74, in particular a steering column or the like, can be blocked by a schematically illustrated blocking pin 71. The blocking pin 71 itself has a guide part 71.1, which is directly loaded using a spring element 76, see FIG. 2 in this regard. The blocking pin 71 is activated via a control element 72, in particular the control cams 72.3 and/or 75 provided for this purpose.

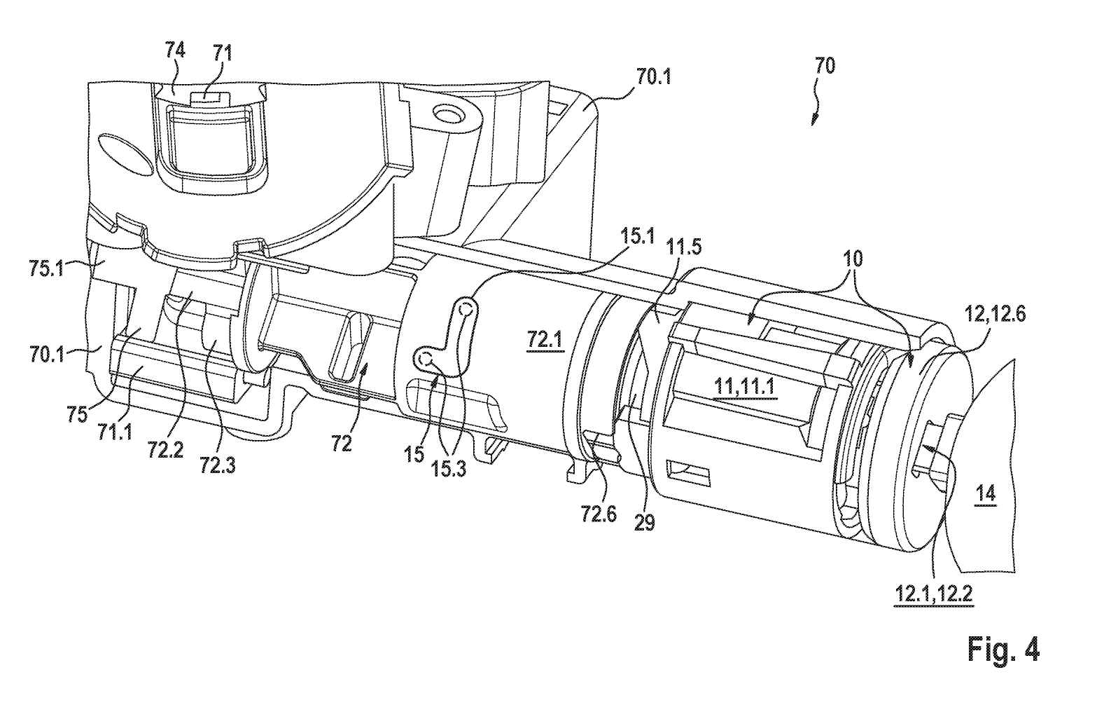

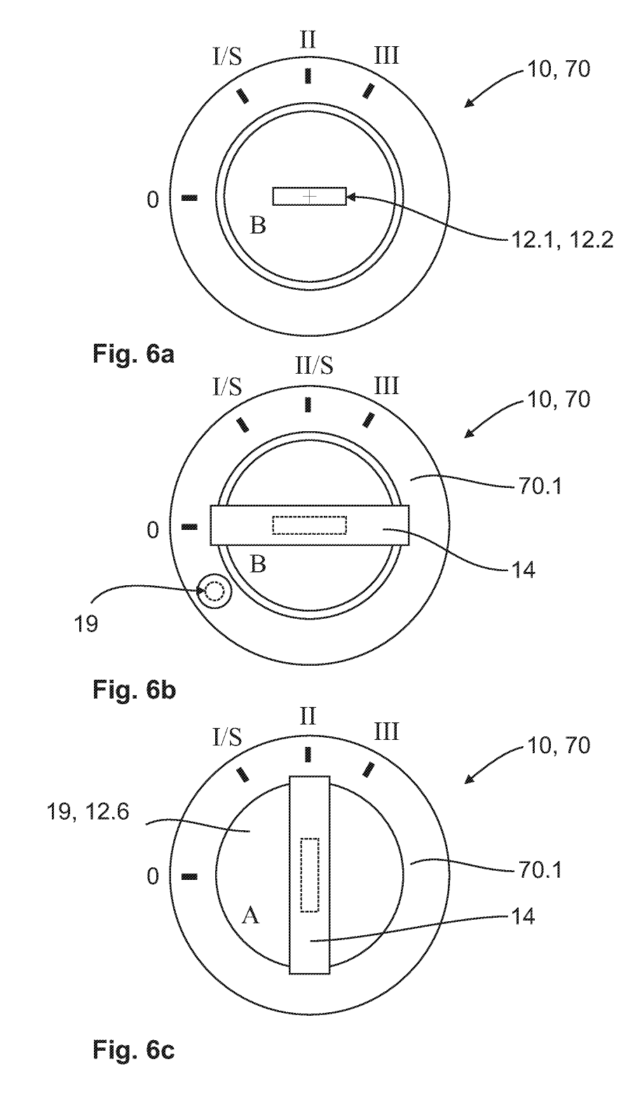

The more precise mechanical functionality of the blocking pin drive results from FIG. 2. It can be seen in this case that the first control cam 72.3 or the second control cam 75 executes a rotational movement (see arrow) about an axis of rotation of the control element 72. In this case, the control cams 72.3 or 75 contact an L-shaped shoulder on the guide part 71.1 of the spring-loaded locking pin 71. This is pushed back and forth between its locked and unlocked position by the rotational movement in the longitudinal direction (see longitudinal arrow adjacent to the guide part). In the locking position, the blocking pin 71 blocks or fixes the functionally essential part 74 in a formfitting manner, in that it extends between two teeth of the functionally-essential component, see FIG. 4. A backward rotation of the control element 72 results in a rotation of the two control cams 72.3 and 75, which are arranged in a rotationally-fixed manner on a transmission part 72.2. Finally, the rotational movement of the control element 72 is initiated by way of the operating part 10 or the lock cylinder 10, which is actuable by a matching key 14, see FIGS. 1 and 4. The individual rotational positions of the operating part 10 or the cylinder core 12 of the lock cylinder 10 in the cylinder housing 11 are shown and described in greater detail in FIGS. 6a to c. To increase the security of the locking device 70 according to the invention, a reset barrier 15 is provided. As can be seen well from FIGS. 1, 3, and 4, the reset barrier 15 is formed by a blocking curve 15.1 on the control element 72 and a stationary guide cam 15.3. The stationary guide cam 15.3 can be arranged for this purpose in the housing 70.1 of the locking device 70. In the present figures, the locking device 70 is shown as a steering wheel lock.

The reset barrier 15 prevents a reset of the operating part 10 or the cylinder core 12 from a start position III directly into the off position 0 from being possible. Rather, the reset barrier 15 has to be performed by a press on the operating part 10 or the cylinder core 12 in a blocking position S to be able to cancel out an existing form fit (see blocking location A or release location B of the reset barrier) between the stationary guide cam 15.3 and a projection 15.2 in the blocking curve 15.1. The blocking position S can correspond in this case to the rotational position I or II, which will be described in greater detail hereafter. The manually initiated pressure on the operating part 10 or the key 14 results (only in the blocking position S as a result of the control curve 10.1) in a longitudinal movement (in particular of the cylinder core 12), which is transmitted to the control element 72, whereby the form fit between the projection 15.2 of the blocking curve 15.1 and the stationary guide cam 15.3 is canceled out and a further reset, this means a rotational movement, from the blocking position S in the direction of the off position 0 is released (release location B). The corresponding blocking curve 15.1 is schematically illustrated in FIGS. 1, 3, and 5 in interaction with the indicated stationary guide cam 15.3.

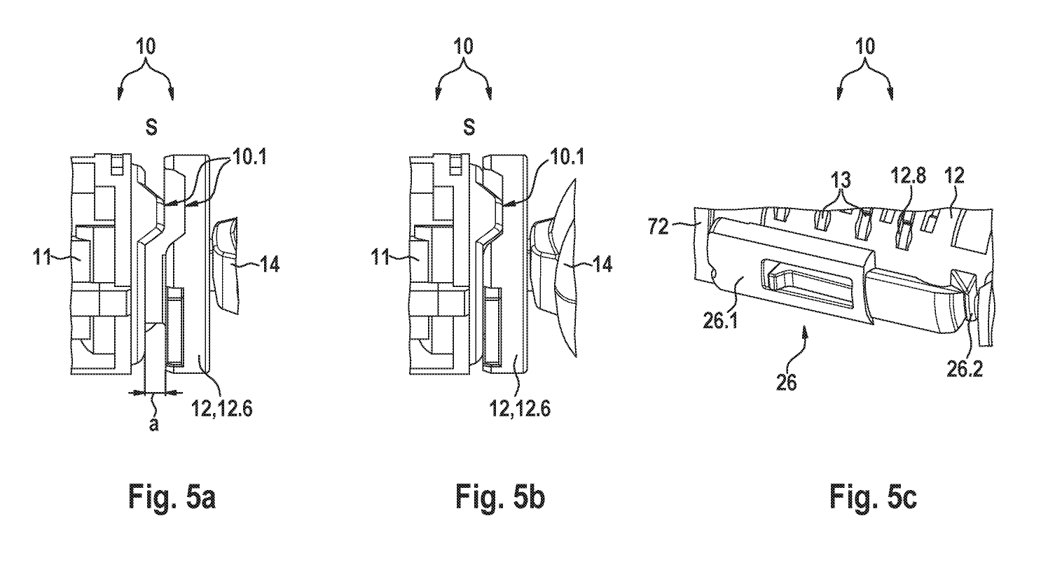

In order that the operating part 10 or the cylinder core 12 may be pressed into the cylinder housing 11, the control curve 10.1 is provided. A longitudinal displacement of the cylinder core 12 in relation to the cylinder housing 11 is therefore only provided in the blocking position S. The control curve 10.1 consists of a recess (on the cylinder core 12), which interacts with a cam-shaped bulge (on the cylinder housing 11) and therefore only permits a longitudinal displacement in the blocking position S, because only in this case can the bulge plunge into the recess of the control curve 10.1. Otherwise, the control curve 10.1 prevents a longitudinal displacement of the cylinder core 12 in relation to the cylinder housing 11 outside the blocking position S. In FIGS. 5a and 5b, the functionality of the control curve 10.1 of the operating part 10 or the lock cylinder 10 is shown. In FIG. 5a, a distance a or gap a between the cylinder core 12 and the cylinder housing 11 is clearly recognizable, which is reduced by a pressure movement on the operating part 10 or the cylinder core 12 and results in a longitudinal movement, in particular of the control element 72, to reach a release location B for the reset barrier 15 (disengagement of the form fit).

To be able to replace the lock cylinder 10 inside the locking device 70, a replacement barrier 28 is provided. This interacts in a formfitting manner between the lock cylinder 10, in particular the cylinder housing 11, and the housing 70.1 of the locking device 70. For this purpose, a curved blocking part 28.1 is provided in a lateral surface 11.1 of the cylinder housing 11, which protrudes out of the lock cylinder 10 (in the installed state) and plunges into a corresponding inner recess in the housing 70.1 to secure the lock cylinder 10. This curved blocking part 28.1 can be retracted in the blocking position S by a tool in the lock cylinder 10, so that the existing form fit (between lock cylinder 10 and housing 70.1) is canceled out and the lock cylinder 10 is replaceable.

To transmit the rotational movement of the cylinder core 12 to the control element 72, a driver 29 is provided. This driver 29 is integrally joined to the cylinder core 12 and has an axial extension. This driver 29 protrudes into a recess 30, which is embodied as geometrically complementary, on the control element 72 and forms a rotationally-fixed connection. A rotational movement is therefore transmitted from the lock cylinder 10 or the operating part 10 to the control element 72. To generate a longitudinal displacement of the control element 72 by way of a rotation of the operating part 10 or the lock cylinder 10, in particular the cylinder core 12, a counter stroke curve 11.5 for a control contour 72.6 on the control element 72 is provided on the cylinder housing 11. In addition, a key withdrawal safeguard 25 is provided, which holds the control element 72 in its longitudinal position via an extendable fixing cam 26.1. This extendable fixing cam 26.1 can interact in this case with a key sensor 26.2 for the key 14, whereby the extendable fixing cam 26.1 is blocked in the off position 0 by the key until it is guided past the key sensor 26.2, in which it is withdrawn from the key channel, see, inter alia, FIGS. 1 and 5c in this regard. In FIG. 5c, the blocking elements 13 of the lock cylinder 10 are also shown inside the blocking element receptacles 12.8 thereof of the cylinder core 12. As long as the matching key 14 is not inserted in the key channel 12.1 of the cylinder core 12 through an insertion opening 12.2, the blocking elements 13 form a form fit between the cylinder core 12 and the cylinder housing 11.

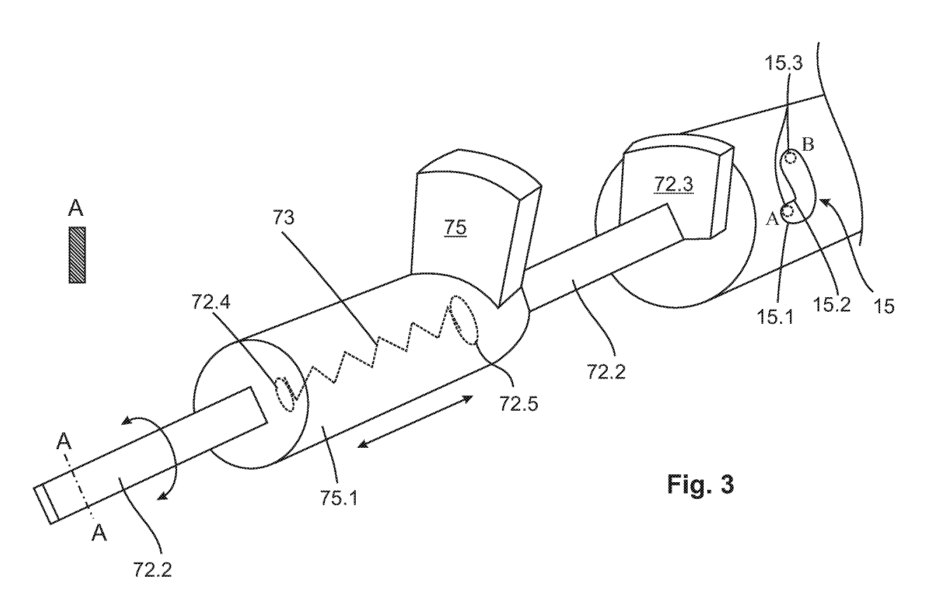

As can be seen well from FIGS. 1 and 3, a first control cam 72.3 is arranged, in particular integrally joined, at the opposing end of the control element 72 in relation to the lock cylinder 10. The transmission part 72.2 is also provided here, on which the second control cam 75 is also pushed on axially, spring-loaded by the spring element 76. For better comprehension, the spring element 73 is shown by dashed lines in FIGS. 1 and 3, although it is arranged inside the ring-shaped recess in the sleeve-shaped region 75.1 of the second control cam 75. To hold the second control cam 75 on the axially embodied transmission part 72.2 in spite of the spring element 73, on the one hand, a bulge 72.4 is provided for the axial securing. On the other hand, the transmission part 72.2 also has a ring-shaped shoulder 72.5, on which the spring element 76 can be supported. As can also be seen from the schematically indicated section A-A of the transmission part 72.2, the transmission part 72.2 is also constructed from a multi-tooth or polygonal section, to be able to form a rotationally-fixed movement between the control element 72 and the ignition switch 50. The ignition switch 50 itself has a starting repetition barrier 27 (see FIG. 1).

FIG. 6a shows a schematic top view of a locking device 70 according to the invention having an operating part 10 or a lock cylinder 10. In this case, the individual predefined rotational positions 0 to III of the operating part 10 or a cylinder core 12, which is rotatably mounted in the cylinder housing 11 of the lock cylinder 10, can be seen well. For this purpose, a key channel 12.1 is provided in the cylinder core 12, into which the key 14 is insertable with its key bit. For this purpose, an insertion opening 12.2 is provided frontally on the lock cylinder 10 for the key 14 in the cylinder core 12, wherein the cylinder core 12 can be covered using a cap 12.6. Using the matching key 14, the cylinder core 12 can be rotated into at least three stable rotational positions, namely the off position 0, the ACC position I , and the travel position II. In addition, still a further rotational position exists, namely the start position III, which represents an unstable rotational position for the cylinder core 12 or the operating part 10, however, because in this rotational position, a counter rotational force acts on the cylinder core 12 to move it back into the travel position II. As can be seen well from FIG. 6, the cylinder core 12 is typically rotated clockwise from the off position 0 into the following rotational positions I, II, and III. The reset of the cylinder core 12 from the travel position II into the ACC position I or additionally into the off position 0 is blocked by the existing reset barrier 15 from the blocking position S. To nonetheless reach the ACC position I or off position 0, an actuation of the reset barrier 15 has to be performed via an actuating element 19, in the form of the key 14 or the operating part 10, so that the reset barrier 15 is transferred from its blocking location A into a release location B, where the cylinder core 12 can again be actuated by a simple backward rotation. In FIG. 6a, the cylinder core 12 is used simultaneously as the actuating element 19 and operating part 10 for the reset barrier 15. In this case, the cylinder core 12 can be pressed in in the travel position II to overcome the reset barrier 15.

In FIG. 6b, the above-mentioned actuating element 19 is provided as a button. This actuating button is to be pressed in the present example, in order to actuate the reset barrier 15 so that the cylinder core 12 can be rotated counterclockwise by the matching key 14 from its travel position II to the ACC position I or even the off position 0. In FIGS. 6b and 6c, a key 14 is also inserted into the key channel 12.1 for illustration. However, in FIG. 6b, the cylinder core 12 is still in the off position 0, so that the key 14 is inserted into the cylinder 12, but clockwise rotation has not yet been performed. In this case, most electrical consumers are typically turned off in a steering wheel lock 70 for a vehicle. Furthermore, the blocking position S of the reset barrier 15 is optionally provided in the ACC position I or the travel position II.

In FIG. 6c, a differently embodied actuating element 19 is used for the reset barrier 15. The actuating element 19 is specifically embodied as a ring or cap 12.6. This ring or the cap 12.6 also has to be pressed in to actuate the reset barrier 15. In FIG. 6c, the cylinder core 12 is at the travel position II, so that a simple backward rotation counterclockwise to the ACC position I is only possible by an actuation (this means by a press) of the reset barrier 15.

### LIST OF REFERENCE SIGNS

10 operating part/lock cylinder

10.1 control curve

11 cylinder housing

11.1 lateral surface

11.5 counter stroke contour for 72.6

cylinder core

12.1 key channel for 14

12.2 insertion opening for 14

12.6 cap

12.8 blocking element receptacle

13 blocking element for 12

14 key

15 reset barrier

15.1 blocking curve

15.2 projection in 15.2

15.3 stationary guide cam, can also be used as a transport safeguard

19 actuating element

26 key withdrawal safeguard

26.1 extendable fixing cam

26.2 key sensor

27 starting repetition barrier

28 replacement barrier

28.1 curved blocking part

29 driver

30 recess

50 ignition switch

70 locking device, in particular steering wheel lock

70.1 housing of 70

71 blocking pin for functionally-essential component

71.1 guide part for 71

72 control element for 71

72.1 cylindrical region

72.2 transmission part for 50

72.3 first control cam (primary control cam)

72.4 bulge for axially securing 75

72.5 ring-shaped shoulder for 73

72.6 control contour for counter stroke 11.5

73 spring element

74 functionally-essential component, in particular steering column or the like

75 second control cam (secondary control cam, optionally to 72.3)

75.1 sleeve-shaped region having recess for 73

76 spring element

a distance between 11 and 12

Locations of the Reset Barrier

A blocking location of 15

B release location of 15

Positions of Cylinder Core:

0 off position

I ACC position

II travel position

III start position

S blocking position

What is claimed is:

1. A locking device, in particular a steering wheel lock for a vehicle, for a functionally-essential component, in particular in the form of a steering column or a gearshift lever or the like, having at least one manually actuable, in particular rotatable, operating part,
wherein at least two rotational positions can be assumed by the operating part,
namely an off position and a start position, wherein
in the off position, at least at least one engine of the vehicle can be turned off or the functionally-essential component can be fixed in a locked position by a blocking pin, and in the start position, at least at least one consumer, in particular a starter of the vehicle, can be turned on or the functionally-essential component can be released in an unlocked position by a blocking pin,
characterized in that
a mechanical reset barrier is provided,
which prevents a reset of the operating part at least from the start position into the off position by a, in particular simple, rotation of the operating part into a blocking position,
wherein the mechanical reset barrier is formed by a control element, which mechanically interacts at least with the operating part, and a stationary guide cam, which jointly fix the operating part at least in a formfitting manner in the blocking position.

2. The locking device, in particular in the form of a steering wheel lock for a vehicle, according to claim 1,
characterized in that
the rotatable operating part is embodied in the form of a lock cylinder, which is actuable by a key,
wherein the lock cylinder has at least one cylinder housing and one cylinder core, and the cylinder core is at least rotatably accommodated in the cylinder housing,
wherein at least one blocking element is provided in the cylinder core which, in a blocking position, prevents a rotation of the cylinder core in the cylinder housing and, in a release position, releases a rotation in the cylinder housing, and
wherein a key channel extends through the cylinder core, into which the key is insertable and using which the blocking element is movable between the blocking position and the release position, and
wherein at least two rotational positions can be assumed by the cylinder core, wherein the key is insertable into and removable from the key channel in the off position.

3. The locking device according to claim 1,
characterized in that
the control element is connected in a rotationally-fixed manner to the operating part or the cylinder core,
wherein in particular a driver is provided between operating part or cylinder core and control element for the rotationally-fixed connection.

4. The locking device according to claim 1,
characterized in that
the control element is mounted so it is axially displaceable in relation to the operating part or the cylinder core, in particular by a driver,
wherein in particular the driver is embodied as a multi-tooth axis on the operating part or cylinder core and interacts with a recess, which is embodied as geometrically complementary, on the control element, in order to form the rotationally-fixed connection.

5. The locking device according to claim 1,
characterized in that
the control element has a blocking curve, in which the stationary guide cam engages, whereby the mechanical reset barrier is formed,
and wherein in particular a projection is provided in the blocking curve to hold the guide cam in the blocking position in a formfitting manner.

6. The locking device according to claim 5,
characterized in that
the blocking curve is arranged on the outside of the control element,
wherein in particular the control element has a cylindrical region, to which the blocking curve is worked.

7. The locking device according to claim 1,
characterized in that
at least one first control cam for an actuation of a blocking pin is provided on the control element,
wherein in particular the control cam is arranged radially on a transmission part.

8. The locking device according to claim 1,
characterized in that
at least one second control cam, which is provided for an actuation of a blocking pin, in particular in the blocking position, is arranged in a longitudinally displaceable and rotationally-fixed manner on a transmission part of the control element, which is embodied as axle-shaped in particular,
wherein in particular a spring element is provided between the second control cam and the control element.

9. The locking device according to claim 1,
characterized in that
a transmission part of the control element transmits a rotational movement of the control element to an ignition switch.

10. The locking device according to claim 7,
characterized in that
at least the first and second control cams are arranged axially offset on the transmission part of the control element and both interact with the blocking pin to move it back and forth between a locked and unlocked position or hold it.

11. The locking device according to claim 8,
characterized in that
at least the first and second control cams are arranged axially offset on the transmission part of the control element and both interact with the blocking pin to move it back and forth between a locked and unlocked position or hold it.

12. The locking device according to claim 1,
characterized in that
a movement direction of the blocking pin is arranged transversely in relation to the rotational axis of the control element,
wherein in particular the blocking pin is supported by a spring element and is pressed into the locked position.

13. The locking device according to claim 2,
characterized in that
a control contour, in particular for the blocking position, is provided on the control element, which interacts with a counter stroke contour on the lock cylinder, in particular on the cylinder housing, to cause an axial displacement of the control element upon a rotation of the operating part or the cylinder core.

14. The locking device according to claim 2,
characterized in that
an (in particular solely mechanical) key withdrawal safeguard (26) is provided, to hold the blocking pin in the unlocked position until the key is withdrawn in the position from the lock cylinder,
wherein in particular the key withdrawal safeguard is formed on the lock cylinder and fixes the control element axially in its displaced location at least in the off position, for which in particular an extendable fixing cam is provided on the key withdrawal safeguard.

15. The locking device according to claim 2,
characterized in that
the operating part or the cylinder core is mounted so it is rotatable and axially displaceable in its release position, in particular using the matching key for the cylinder housing,
wherein in particular only an axial displacement is possible in the region of the blocking position due to a control curve.

16. The locking device according to claim 1,
characterized in that
an axial displacement of the operating part or the cylinder core is used to overcome the form fit of the reset barrier in the blocking position.

17. The locking device according to claim 5,
characterized in that
the form fit between the projection in the blocking curve and the stationary guide cam can be canceled out by the axial displacement of the operating part or the cylinder core in relation to the cylinder housing in the blocking position, whereby a reset of the operating part or the cylinder core in the direction of the off position is implementable.

18. The locking device according to claim 1,
characterized in that
the lock cylinder is arranged so it is replaceable in the housing of the steering wheel lock by way of a replacement barrier,
wherein in particular the replacement barrier is only actuable in the blocking position of the cylinder core, and
wherein in particular the replacement barrier forms a form fit between the lock cylinder, in particular the cylinder housing, and the housing of the lock device to secure the lock cylinder.

19. The locking device according to claim 18,
characterized in that
the stationary guide cam is formed as stationary in relation to the housing of the locking device
and in particular at least is fixedly connected thereto or is formed by the housing itself.

20. The locking device according to claim 18,
characterized in that
the stationary guide cam is stationary in its position in relation to the housing, wherein in particular the guide cam is embodied as spring-loaded and retractable.

21. The locking device according to claim 9,
characterized in that
a starting repetition barrier is provided on or in the ignition switch to block a repeated rotation of the operating part or the cylinder core into the start position without reset.
